(19) United States
(12) Patent Application Publication
(10) Pub. No.: US 2022/0413409 A1
(43) Pub. Date: Dec. 29, 2022

(54) ELECTROPHOTOGRAPHIC APPARATUS

(71) Applicant: SHARP KABUSHIKI KAISHA, Sakai City (JP)

(72) Inventor: Yoshiaki TOKUMURA, Sakai City (JP)

(21) Appl. No.: 17/837,802

(22) Filed: Jun. 10, 2022

(30) Foreign Application Priority Data
Jun. 28, 2021 (JP) 2021-106837

(51) Int. Cl. G03G 9/097; G03G 9/087; G03G 9/08

(52) U.S. Cl. CPC G03G 9/09725; G03G 9/08795; G03G 9/0819

(57) ABSTRACT

An electrophotographic apparatus forms an image by forming an electrostatic latent image on the surface of an electrophotographic photoconductor and transferring a toner developed in the electrostatic latent image to a transfer material, where the photoconductor includes an outermost layer containing a silica filler, where the toner includes a toner base particle and an external additive as components, where the toner base particles at least contains a binder resin, a colorant, and a mold lubricant, and where the external additive represents externally-added silica and externally-added fine powder, the externally-added fine powder having the surface of a core hydrophobized with a silane compound, the core being derived by addition of silica to strontium titanate.

### BACKGROUND OF THE INVENTION

### Field of the Invention

The present disclosure relates to an electrophotographic apparatus that can achieves extended long-life of an electrophotographic photoconductor (hereinafter also referred to as “photoconductor”) with retaining environmental stability.

### Description of the Background Art

Recently, with remarkable development of office automation equipment, electrophotographic apparatuses (image-forming apparatuses) using electrography have been widely spread, such as copiers, printers, and facsimile apparatuses.

Additionally, with advancing increase in use of contact charging systems with roller charging, or extension of long-life, miniaturization, and speed-up of electrophotographic devises such as digital copiers and printers, electrophotographic devises and toners used therefor have been required to have various functions.

For example, as a technology for improving environmental variance in image formation, Japanese Unexamined Patent Application Publication No. 2015-084095 proposes a toner that contains toner particles containing a binder resin, a wax, and a colorant, and silica microparticles and strontium titanate microparticles present on the surface of the toner particles, in which the silica microparticles have a specific number mean particle diameter and negative charge and is formed by sticking to the surface of the toner particle with a specific coverage and covering ratio, and in which the strontium titanate microparticles has positive charge. Japanese Unexamined Patent Application Publication No. 2015-084095 also describes that the strontium titanate microparticle preferably has a surface treated fatty acid or metallic salt of fatty acid.

In Japanese Unexamined Patent Application Publication No. 2015-084095, environmental variance in image formation is improved by, e.g., presence of strontium titanate microparticles together with silica microparticles on the surface of toner particle. However, the technology in Japanese Unexamined Patent Application Publication No. 2015-084095 has a problem in that regardless of presence or absence of the surface treatment, a physical property of strontium titanate microparticles themselves causes more abrasion of a photoconductor drum, thus adversely affecting image formation, and reducing a life of an electrophotographic photoconductor.

Then, the present disclosure has an object to provide an electrophotographic apparatus that can achieve extended long-life of an electrophotographic photoconductor with retaining environmental stability.

### SUMMARY OF THE INVENTION

The inventors earnestly made investigation to solve the problem described above, and consequently found that a toner having external addition of externally-added silica and externally-added fine powder that has the surface of a core hydrophobized with a silane compound, in which the core is derived by addition of silica to strontium titanate, can be used for an electrophotographic apparatus including an outermost surface layer containing a silica filler, thereby reducing abrasion of a photoconductor drum (improving abradability) and achieving extended long-life, and finally, the present disclosure was completed.

Thus, the present disclosure provides an electrophotographic apparatus that forms an image by forming an electrostatic latent image on the surface of an electrophotographic photoconductor and transferring a toner developed in the electrostatic latent image to a transfer material, wherein the electrophotographic photoconductor includes an outermost layer containing a silica filler, wherein the toner includes a toner base particle and an external additive as components, in which the toner base particle at least contain a binder resin, a colorant, and a mold lubricant, and wherein the external additive represents externally-added silica and externally-added fine powder that has the surface of a core hydrophobized with a silane compound, in which the core is derived by addition of silica to strontium titanate.

The present disclosure can provide an electrophotographic apparatus that can achieve extended long-life of an electrophotographic photoconductor with retaining environmental stability.

That is, it is expected that the present disclosure can provide a smoother angle (spheroidization) of strontium titanate in the externally-added fine powder having the surface of a silica-added core hydrophobized with a silane compound, and appropriately reduce abradability to a photoconductor drum, thereby achieving extended long-life, as well as optimizing chargeability.

### BRIEF DESCRIPTION OF THE DRAWINGS

FIG. 1 is a typical side view illustrating a configuration of a main part of an electrophotographic apparatus according to an embodiment of the present disclosure.

FIG. 2 is a schematic cross-sectional view illustrating a configuration of a main part of an exemplary electrophotographic photoconductor (stacked photoconductor) mounted in the electrophotographic apparatus according to an embodiment of the present disclosure.

DESCRIPTION OF THE PREFERRED EMBODIMENTS

(1) Electrophotographic Apparatus

The electrophotographic apparatus according to an embodiment of the present disclosure is an electrophotographic apparatus that forms an image by forming an electrostatic latent image on the surface of an electrophotographic photoconductor and transferring a toner developed in the electrostatic latent image to a transfer material, wherein the electrophotographic photoconductor includes an outermost layer containing a silica filler, wherein the toner includes a toner base particle and an external additive as components, in which the toner base particle at least contain a hinder resin, a colorant, and a mold lubricant, and wherein the external additive represents externally-added silica and externally-added fine powder that has the surface of a core hydrophobized with a silane compound, in which the core is derived by addition of silica to strontium titanate.

Hereinafter, the external additive, which is a feature of the toner according to an embodiment of the present disclosure, will be described, and description will be made for a toner base particle, which is a basic component of the toner, a method of producing the toner, a two-component developing agent containing the toner, and an electrophotographic apparatus to which the toner according to an embodiment of the present disclosure is applied.

(1-1) External Additive

The external additive generally has functions for improving conveyability and chargeability of a toner, as well as stirring efficiency with a carrier in use of a two-component developing agent as a toner, and the like. The external additive of the toner according to an embodiment of the present disclosure includes externally-added silica, and externally-added fine powder that has the surface of a core hydrophobized with a silane compound, in which the core is derived by addition of silica to strontium titanate.

(1-1-1) Externally-Added Silica

The externally-added silica preferably has a mean primary particle diameter of 40 nm or less.

When the mean primary particle diameter of the externally-added silica is more than 40 nm, an effect for providing a toner with flowability may be reduced, thereby generating toner scattering due to failure in mixing of the toner. Alternatively, when the mean primary particle diameter of the externally-added silica is too small, embedment into the toner particle may be too excessive to sufficiently adjust chargeability and flowability throughout durable use, and the lower limit is about 6 nm.

The mean primary particle diameter of the externally-added silica is preferably 6-17 nm, and more preferably 7-12 nm.

Examples of the externally-added silica include silica particles commonly used in the art, e.g., dry silica particles such as fumed silica derived by burning silicon tetrachloride, and arc silica derived by forming silica into microparticles in a vapor phase with high energy such as plasma; wet silica particles such as precipitated silica derived by synthesis from an aqueous sodium silicate solution as a raw material in an alkaline condition, and gelled silica derived by synthesis in an acid condition; colloidal silica particles derived by alkalifying and polymerizing acidic silicate; and sol-gel silica particles derived by hydrolysis of an organic silane compound. To improve an electrical property of a photoconductor, surface finishing may be made with a surface finishing agent.

Examples of the surface finishing agents include surface finishing agents commonly used in the art, such as hexamethyldisilazane (HMDS), dimethyl-dichlorosilane (DDS), octylsilane (OTAS), and polydimethylsiloxane (PDMS).

A commercially-available, hydrophobized silica particles may be used, and non-hydrophobized silica particles may be subjected to finishing to be used.

(1-1-2) Externally-Added Fine Powder

In the externally-added fine powder, the surface of a core derived by addition of silica to strontium titanate is hydrophobized with a silane compound. The externally-added fine powder is not particularly limited, but can be produced, by, e.g., the following method.

Solution 1, which is derived from metatitanic acid adjusted to pH 1.0 to be peptized with hydrochronic acid, Solution 2, which is an aqueous strontium chloride solution, and Solution 3, which is an aqueous sodium silicate solution, are mixed in a ratio so as to provide a molar ratio of (Sr+Si)/Ti of 1.2. The mixture solution thus obtained is heated at a temperature of 80° C. under nitrogen gas atmosphere, followed by addition of an aqueous sodium hydroxide at a speed of 1 equivalent/hour, and the fine powder thus obtained is surface-finished with a silane coupling agent by a surface finishing method commonly used in the art, thereby enabling production.

Examples of the silane coupling agents include hexamethyldisilazane (HMDS), dimethyl-dichlorosilane (DDS), octylsilane (OTA), and polydimethylsiloxane (PDMS).

The molar ratio Si/Ti of silicon Si in silica to titanium Ti in strontium titanate in the externally-added fine powder is not particularly limited, but is preferably 0.03 or more to less than 1.0.

When the molar ratio Si/Ti is less than 0.04, the externally-added fine powder has higher electrical conductivity; then when a toner with external addition of such powder is left under high-humidity environment, charge decrease speed may be accelerated, thus leading to increase in a fog value. Alternatively, when the molar ratio Si/Ti is 1 or more, negative-charging property of silica is strongly exerted; thus when a toner with external addition of the externally-added fine powder is subjected to serial printing under low-humidity environment, charging of the toner may be excessive and deteriorate of mixing with the toner supplied from a cartridge, thus leading to increase in a fog value due to toner scattering.

The mean primary particle diameter of the externally-added fine powder is about 30-50 nm.

The mean primary particle diameter of the externally-added fine powder is preferably larger than the mean primary particle diameter of the externally-added silica. In addition, when the mean primary particle diameter of the externally-added fine powder is smaller than the mean primary particle diameter of the externally-added silica, abradability may not be exerted.

The mean primary particle diameter of the externally-added fine powder is preferably 35-45 nm.

(1-1-3) External Addition Amount of External Additive

The external addition amount of the externally-added silica is an amount corresponding to a coverage of 50-120% for the toner base particle. When the external addition amount of the externally-added silica is an amount corresponding to a coverage of less than 50% for the toner base particle, the toner had reduced charge amount, but may have reduced flowability. Alternatively, when the external addition amount of the externally-added silica is an amount corresponding to a coverage of more than 120% for the toner base particle, the externally-added silica may come off from the toner base particles, thereby contaminating a developing agent. The external addition amount of the externally-added silica is preferably an amount corresponding to a coverage of 50-100% for the toner base particle, and more preferably 80-100%.

The external addition amount of the externally-added fine powder is preferably an amount corresponding to a coverage of 2-10% for the toner base particle.

When the external addition amount of the externally-added fine powder is an amount corresponding to a coverage of less than 2% for the toner base particle, an effect of the present disclosure may not be exerted. Alternatively, when the external addition amount of the externally-added fine powder is an amount corresponding to a coverage of more than 10% for the toner base particle, the fine powder may have more effect to reduce a charge amount of the toner, thus leading to excess reduction in the charge amount.

More preferably; the external addition amount of the externally-added fine powder is an amount corresponding to a coverage of 3-6% for the toner base particle.

The term “coverage” as used herein is a value calculated from the mean primary particle diameter of the external additive and the surface area of the toner base particle, assuming that respective particles of the external additive have the same particle diameter of their mean primary particle diameter as the whole surface of the toner base particle covered with the external additive in a closest packing manner is defined as 100%. A particular method of measuring an external addition amount will be described in the example.

(1-1-4) Adhesion Strength of External Additive

In the toner according to an embodiment of the present disclosure, the ratio b/a of adhesion strength of the externally-added fine powder b to adhesion strength of the externally-added silica a for the toner base particle preferably meets a relation of 0.15≤a≤0.5.

When the adhesion strength ratio b/a is less than 0.15, adhesion strength of the externally-added fine powder b is small, and the externally-added fine powder may come off from the toner base particle, thus failing to exert desired chargeability. Alternatively, when the adhesion strength ratio b/a is more than 0.5, adhesion strength of the externally-added fine powder b is large, and the externally-added fine powder may not come off from the toner base particle, thus failing to provide a cleaning effect.

Note that the cleaning effect is exerted by the externally-added fine powder appropriately coming off from the toner base particle and being present between a photoconductor drum and a cleaning roller.

The adhesion strength ratio b/a is more preferably 0.20≤a≤0.3.

A particular method of measuring adhesion strength will be described in the example.

(1-2) Toner Base Particle

The toner base particle contained in the toner according to an embodiment of the present disclosure includes at least a binder resin, a colorant, and a mold lubricant, and may include a known additive in the range not inhibiting an effect of the present; disclosure, if required.

(1-2-1) Binder Resin

As the binder resin contained in the toner according to an embodiment of the present disclosure, polyester-based resin can be preferably used.

Polyester-based resin can commonly derived by condensation polymerization reaction, esterification, or transesterification reaction of one or more selected from dihydric alcohol components and trihydric or higher polyhydric alcohol components with one or more selected from dicarboxylic acids and tricarboxylic or higher polycarboxylic acids, by a known method. The condition in the condensation polymerization reaction only needs to be appropriately set depending on reactivity of a monomer component, and furthermore, the reaction only need to be terminated at the time that a polymer has a preferred physical property. For example, a reaction temperature is about 170-250° C., and a reaction pressure is about 5 mmHg to normal pressure.

Examples of the dihydric alcohol components include alkyleneoxide adducts of bisphenol A such as polyoxypropylene(2.2)-2,2-bis(4-hydroxyphenyl)propane, polyoxypropylene(3.3)-2,2-bis(4-hydroxyphenyl)propane, polyoxypropylene(2.0)-2,2-bis(4-hydroxyphenyl)propane, polyoxypropylene(2.0)-polyoxyethylene(2.0)-2,2-bis(4-hydroxyphenyl)propane, and polyoxypropylene(6)-2,2-bis(4-hydroxyphenyl)propane; diols such as ethylene glycol, diethylene glycol, triethylene glycol, 1,2-propyleneglycol, 1,3-propyleneglycol, 1,4-butanediol, neopentylglycol, 1,4-butenediol, 1,5-pentanediol, 1,6-hexanediol, 1,4-cyclohexanedimethanol, dipropyleneglycol, polyethylene glycol, polypropylene glycol, and polytetramethylene glycol; bisphenol A; propylene adducts of bisphenol A; ethylene adducts of bisphenol A; and hydrogenated bisphenol A.

Examples of the trihydric or higher polyhydric alcohol components include sorbitol, 1,2,3,6-hexanetetrol, 1,4-sorbitan, pentaerythritol, dipentaerythritol, tripentaerythritol, sucrose (saccharose), 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

The toner according to an embodiment of the present disclosure can employ a single one of or a combination of two or more of the dihydric alcohol components and trihydric or higher polyhydric alcohol components described above.

Examples of the dicarboxylic acids include maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, n-dodecenylsuccinic acid, n-dodecylsuccinic acid, n-octylsuccinic acid, isooctenylsuccinic acid, isooctylsuccinic acid, and acid anhydrides or lower alkyl esters thereof.

Examples of the tricarboxylic or higher polycarboxylic acid include 1,2,4-benzenetricarboxylic acid, 1,2,5-benzenetricarboxylic acid, 2,5,7-naphthalenetricarboxylic acid, 1,2,4-naphthalenetricarboxylic 1,2,4-butanetricarboxylic acid, 1,2,5-hexanetricarboxylic acid, 1,3-dicarboxylic-2-methyl-2-methylenecarboxypropane, 1,2,4-cyclohexanetricarboxylic acid, tetra(methylenecarboxylic)methane, 1,2,7,8-octanetetracarboxylic acid, pyromellitic acid, Empol trimer acid, and acid anhydrides or lower alkyl esters thereof.

The toner according to an embodiment of the present disclosure can employ a single one of or a combination of two or more of the dicarboxylic acids and tricarboxylic or higher polycarboxylic acids described above.

In the toner according to an embodiment of the present disclosure, the binder resin preferably has a mass-average molecular weight in the range of 9,000-90,000, in which a proportion of molecular weight of 100,000 or more in the molecular weight distribution is 10-30%. When the mass-average molecular weight and a proportion of molecular weight of 100,000 or more of the binder resin fall within the range described above, more compatible effect of low-temperature fixability and hot offset resistance is exerted in a belt fixing apparatus.

When the binder resin has a mass-average molecular weight of less than 9,000, releasability in a high temperature fixing part is likely to decrease. Alternatively, when the binder resin has a mass-average molecular weight of more than 90,000, low-temperature fixability is likely to decrease.

Setting a mass-average molecular weight of the binder resin to 20,000 or more provides better releasability in a high temperature fixing part more securely, whereas setting a mass-average molecular weight of the binder resin of 70,000 or less provides better low-temperature fixability more securely.

Accordingly, the range of the mass-average molecular weight of the binder resin is more preferably 20,000-70,000.

Additionally when the proportion of the molecular weight of 100,000 or more in the molecular weight distribution of the binder resin is less than 10%, releasability in a high temperature fixing part is likely to decrease. Alternatively, when the proportion of the molecular weight of 100,000 or more in the molecular weight distribution of the binder resin is more than 30%, low-temperature fixability is likely to decrease. Setting the proportion to 20% or less provides better low-temperature fixability more securely. Accordingly, the range of the proportion of molecular weight of 100,000 or more in the molecular weight distribution of the binder resin is more preferably 10-20%.

The formulation amount of the binder resin in the toner base particle is preferably 60-90% by mass, and particularly preferably 70-85% by mass.

(1-2-2) Colorant

As the colorant contained in the toner according to an embodiment of the present disclosure, various kinds and colors of organic and inorganic pigments and dyes commonly used in the art can be employed, and examples include black, white, yellow, orange, red, purple, blue, and green colorants.

Examples of the black colorants include carbon black, copper oxide, manganese dioxide, aniline black, activated carbon, non-magnetic ferrite, magnetic ferrite, and magnetite.

Examples of the white colorants include zinc flower, titanium oxide, and antimony white, and zinc sulfide.

Examples of the yellow colorants include chrome yellow, zinc yellow, cadmium yellow, yellow iron oxide, mineral fast yellow nickel titanium yellow, Navel Yellow, Naphthol Yellow S, Hansa Yellow G, Hansa Yellow 10G, Benzidine Yellow G, Benzidine Yellow GR, Quinoline Yellow Lake, Permanent Yellow NCG, Tartrazine Lake, C.I. Pigment Yellow 12, C.I. Pigment Yellow 13, C.I. Pigment Yellow 14, C.I. Pigment Yellow 15, C.I. Pigment Yellow 17, C.I. Pigment Yellow 93, C.I. Pigment Yellow 94, and C.I. Pigment Yellow 138.

Examples of the orange colorants include red chrome yellow, molybdenum orange, Permanent Orange GTR, Pyrazolone Orange, Vulcan Orange, Indanthrene Brilliant Orange RK, Benzidine Orange Indanthrene Brilliant Orange GK, C.I. Pigment Orange 31, and C.I. Pigment Orange 43.

Examples of the red colorants include red oxide, cadmium red, red lead, mercury sulfide, cadmium, Permanent Red 4R, Lithol Red, Pyrazolone Red, Watching Red, calcium salt, Lake Red C, Lake Red D, Brilliant Carmine 6B, Eosine Lake, Rhodamine Lake B, Alizarin Lake, Brilliant Carmine 3B, C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48: 1, C.I. Pigment Red 53: 1, C.I. Pigment Red 57: 1, C.I. Pigment Red 122, C.I. Pigment Red 13, C.I. Pigment Red 139, C.I. Pigment Red 144, C.I. Pigment Red 149, C.I. Pigment Red 166, C.I. Pigment Red 177, C.I. Pigment Red 178, and C.I. Pigment Red 222.

Examples of the purple colorants include manganese purple, Fast Violet B, and Methyl Violet Lake.

Examples of the blue colorants include iron blue, cobalt blue, Alkaline Blue Lake, Victoria Blue Lake, Phthalocyanine Blue, metal-free Phthalocyanine Blue, Phthalocyanine Blue partial chloride, Fast Sky Blue, Indanthrene Blue BC, C.I. Pigment Blue 15, C.I. Pigment Blue 15: 2, C.I. Pigment Blue 15: 3, C.I. Pigment Blue 16, and CI Pigment Blue 60.

Examples of the green colorants include chrome green, chromium oxide, Pigment Green B, Mica Light Green Lake, Final Yellow Green G, and C.I. Pigment Green 7.

The toner according to an embodiment of the present disclosure can employ a single one of or a combination of two of the colorants described above, and the combination thereof may include different colors or the same color.

In addition, two or more colorants may be formed into composite particles to be used. The composite particles can be manufactured by, e.g., adding an appropriate amount of water, lower alcohol, and the like to two or more colorants, granulating by a common granulator such as a high-speed mill, and drying. Furthermore, this may be formed into masterbatch and be used so as to uniformly disperse the colorants into the binder resin. The composite particles and the masterbatch are admixed into a toner composition in dry mixing.

The content of the colorant in the toner according to an embodiment of the present disclosure is not particularly limited, but is preferably 0.1-20 parts by mass, and more preferably 0.2-10 parts by mass, to 100 parts by mass of the binder resin.

As long as the content of the colorant falls within the range described above, it is possible to have high image density and to form an image with particularly good picture quality, without impairing various physical properties of the toner.

If calculated, the content of the colorant in the toner is preferably 2.5-7.5% by mass, and more preferably 3.0-6.5% by mass.

(1-2-3) Mold Lubricant

As the mold lubricant contained in the toner according to an embodiment of the present disclosure, a mold lubricant commonly used in the art can be employed.

Examples include petroleum waxes such as paraffin wax and microcrystalline wax and derivatives thereof; hydrocarbon-based synthetic waxes such as Fischer-Tropsch wax, polyolefin wax (such as polyethylene wax and polypropylene wax), low-molecular-weight polypropylene wax, and polyolefin-based polymer wax (such as low-molecular-weight polyethylene wax), and derivatives thereof; plant-based waxes such as carnauba wax, rice wax, and candelilla wax, and derivatives thereof, and Japan wax; animal-based waxes such as beeswax and spermaceti wax; oil-and fat-based synthetic waxes such as fatty acid amide and phenolic fatty acid ester; long-chain carboxylic acids and derivatives thereof; long-chain alcohols and derivatives thereof; silicone-based polymers; and higher fatty acids; and among them, hydrocarbon-based wax is preferable.

The derivatives described above include oxides, a block copolymer of vinyl-based monomer and wax, and a graft-modified material of vinyl-based monomer and wax.

The present disclosure can employ a single one of or a combination of two or more of the mold lubricants described above.

The mold lubricant preferably has a melting point of 70° C. or less in view of a compatible effect of low-temperature fixability and hot offset resistance, particularly low-temperature fixability; of the toner in a belt fixing apparatus. The lower limit of the melting point is about 60° C.

The content of the mold lubricant; in the toner according to an embodiment of the present disclosure is not; particularly limited, but is preferably 0.2-20 parts by mass, more preferably 0.5-10 parts by mass, and particularly preferably 1.0-8.0 parts by mass, to 100 parts by mass of the binder resin.

As long as the content of the mold lubricant falls within the range described above, it is possible to have high image density and to form an image with particularly good picture quality, without impairing various physical properties of the toner.

If calculated, the content of the mold lubricant; in the toner is preferably 2.0-7.0% by mass, and more preferably 3.0-5.0% by mass.

(1-2-4) Charge Regulator

The toner base particle in the present disclosure may contain a charge regulator, but preferably contain no charge regulator in order to prevent increase in the charge amount.

As the charge regulator, an electric charge regulator for regulating negative charge, commonly used in the art, can be employed.

Examples of the electric charge regulators for regulating negative charge include oil-soluble dyes such as Oil Black and Spiron Black, metal-containing azo compounds, azo complex dyes, metal salts of naphthenic acid, metal complexes and metal salts of salicylic acid and derivatives thereof (with chromium, zinc, zirconium, or the like as the metal), boron compounds, fatty acid soaps, long-chain alkyl carboxylic acid salts, and resin acid soaps.

The toner according to an embodiment of the present disclosure can employ a single one of or a combination of two or more of the electric charge regulators described above.

The content of the charge regulator in the toner according to an embodiment of the present disclosure is not particularly limited, but is preferably 0.5-3 parts by mass, and more preferably 1-2 parts by mass, to 100 parts by mass of the binder resin.

As long as the content of the charge regulator falls within the range described above, it is possible to have high image density and to form an image with particularly good picture quality, without impairing various physical properties of the toner.

If calculated, the content of the charge regulator in the toner is preferably 0.8% by mass or less.

(1-3) Mean Primary Particle Diameter of Toner

The toner according to an embodiment of the present disclosure preferably has a mean primary particle diameter of 4-10 μm.

With a mean primary particle diameter of less than 4 μm, the toner base particles has a too small particle diameter, possibly causing high charge and less flowability. Once such high charge and less flowability generate, the toner can be no longer supplied stably to a photoconductor, possibly generating ground fog and reduced image density, and the like. Alternatively, with a mean primary particle diameter of more than 10 μm, it is not preferable because the toner base particles has a large particle diameter, which increases bed height of an image thus formed and makes the image have remarkable granularity; thus failing to provide a highly-definition image. Additionally, the larger particle diameter of the toner base particles reduces a specific surface area, leading to less charge amount of the toner. With the less charge amount of the toner, the toner is no longer supplied stably to a photoconductor, possibly generating pollution within an apparatus due to toner scattering. Preferable mean primary particle diameter is 5-7 μm.

(2) Method of Producing Toner

The toner base particles used in the present disclosure can be produced by a known method with a known apparatus commonly used in the art, e.g., by a mixing step to mix a roughly-milled, melt-kneaded material containing at least a binder resin, a colorant, and a mold lubricant, with a filler; a finely-milling step to finely mill the mixture obtained in the mixing step; a classifying step to classify the finely-milled material obtained in the finely-milling step; and a spheroidization step to spheroidize the classified material obtained in the classifying step, with a hot blast.

Dry methods are preferable in view of smaller number of steps and less cost of facilities as compared to wet methods, and among them, grinding methods are particularly preferable.

The condition of each of the steps only need to be set appropriately corresponding to a target material and a desired physical property.

Mixing can employ a known apparatus commonly used in the art, e.g., a Henschel-type mixing apparatus such as Henschel mixer (trade name, manufactured by Mitsui Mining Co., Ltd. (current Nippon Coke and Engineering Co., Ltd.)), Super mixer (trade name, Kawata MFG Co., Ltd.), or Mechanomill (trade name, manufactured by Okada Seiko Co., Ltd.); and a mixing apparatus such as Ongmill (trade name, manufactured by Hosokawa Micron Corporation), Hybridization System (trade name, manufactured by Nara Machinery Co., Ltd.), or Cosmo System (trade name, manufactured by Kawasaki Heavy Industries, Ltd.).

Melt-kneading can employ a known apparatus commonly used in the art, e.g., a common kneader such as a dual-screw extruder, a triple roll, or Labo Plastmill. In particular, examples to be used can be a single- or dual-screw extruder such as TEM-100B (trade name, manufactured by Toshiba Machine Co., Ltd.), PCM-65/87, or PCM-30 (both thereof are trade names, manufactured by Ikegai Corporation), and an open-roll kneader such as Kneadex (trade name, manufactured by Mitsui Mining Co., Ltd.). Finely-milling can employ a known apparatus commonly used in the art, e.g., a jet mill to perform milling with use of supersonic jet stream, and an impact mill to perform milling with introducing a solidified material into a space formed between a rotator (rotor) rotating with high speed and a stator (liner).

Classifying can employ a known apparatus commonly used in the art, e.g., a classifier capable of removing over-milled toner particles by centrifugal force and wind force, such as a rotating air classifier (rotary air classifier).

The toner according to an embodiment of the present disclosure can be produced by a first external addition process to externally add the externally-added silica to the toner base particles, and a second external addition process to further externally add the externally-added fine powder, by a known method with a known apparatus commonly used in the art. The condition of each of the steps only need to be set appropriately corresponding to a target material and a desired physical property.

(3) Two-Component Developing Agent

The toner according to an embodiment of the present disclosure may be a two-component developing agent containing a carrier.

The toner according to an embodiment of the present disclosure can be used in either form of a single-component developing agent and a two-component developing agent. In use as a two-component developing agent, a carrier is further blended in addition to the external additive.

The carrier to be used can be a carrier commonly used in the art, and examples of include single or complex ferrite and carrier core particles formed of iron, copper, zinc, nickel, cobalt, manganese, chromium and the like, and surface-coated with a known covering material.

The mean particle diameter of the carrier is preferably 10-100 μm, and more particularly 20-50 μm.

The formulation amount of the carrier is not, particularly limited, but is preferably 4-15 mass parts, and more preferably 5-10 mass parts, to 100 mass parts of the toner base particles.

(4) Electrophotographic Apparatus

The electrophotographic apparatus according to an embodiment of the present, disclosure is not particularly limited as long as it has the components described above, but examples include an image-forming apparatus that at least, includes an electrophotographic photoconductor, a charging section to charge the electrophotographic photoconductor, an exposing section to expose the electrophotographic photoconductor thus charged and form an electrostatic latent image, a developing section to develop the electrostatic latent image formed by the exposure and form a toner image, a transferring section to transfer on a recording medium the toner image formed by the development, a fixing section to fix on the recording medium the toner image thus transferred and form an image, a cleaning section to remove and recover toner remaining on the electrophotographic photoconductor, and a static eliminating section to eliminate surface charge remaining on the electrophotographic photoconductor.

Hereinafter, description will be made for an exemplary image-forming apparatus and operation thereof on the basis of the drawings, but the present disclosure is not limited thereto.

(4-1) Image-Forming Apparatus

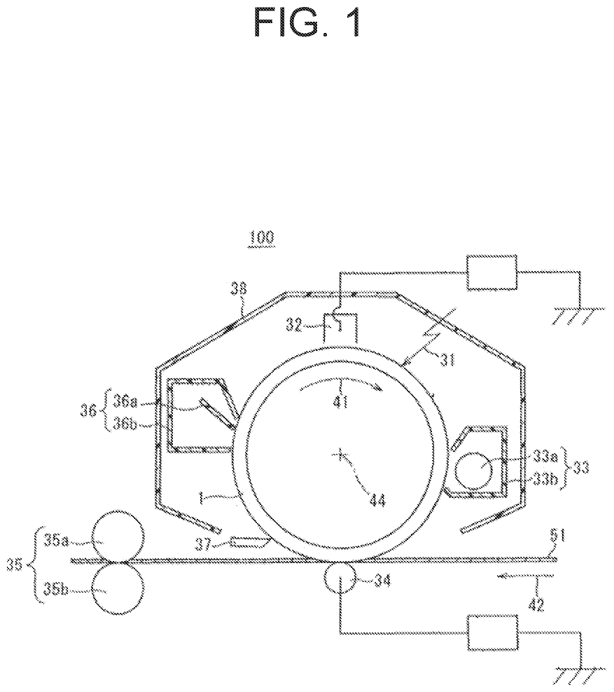

FIG. 1 is a typical side view illustrating a configuration of a main part of an image-forming apparatus 100 according to an embodiment of the present disclosure.

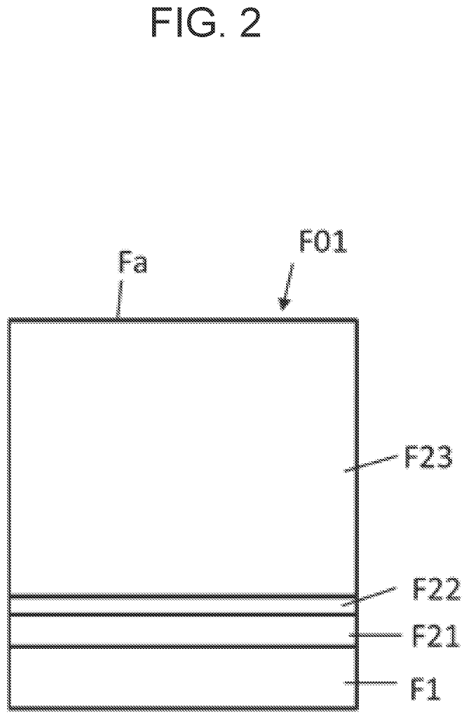

The image-forming apparatus (laser printer) 100 in FIG. 1 is configured with including the photoconductor 1 according to an embodiment of the present disclosure (corresponding to F01 in FIG. 2), an exposing section (semiconductor laser) 31, a charging section (charger) 32, a developing section (developer) 33, a transferring section (transfer charger) 34, a conveying bell (not depicted), a fixing section (fixture) 35, and a cleaning section (cleaner) 36. A symbol 51 indicates a recording medium (a recording paper sheet or a transfer paper sheet).

The photoconductor 1 is rotatably supported in the image-forming apparatus 100 body, and rotationally driven in a direction of an arrow symbol 41 around a rotation axis line 44 by a driving section not depicted. The driving section is configured with including, e.g., an electric motor and a reduction gear, and transmits the driving force to the electrically-conductive base configuring a core body of the photoconductor 1, thereby making the photoconductor 1 rotationally drive at a predetermined circumferential speed. The charging section (charger) 32, the exposing section 31, the developing section (developer) 33, the transferring section (transfer charger) 34, and the cleaning section (cleaner) 36 are arranged in this order, along the outer peripheral face of the photoconductor 1, from an upstream part to a downstream part in a rotation direction of the photoconductor 1 indicated by the arrow symbol 41.

The charger 32 is a charging section that charges uniformly the outer peripheral face of the photoconductor 1 (corresponding to a photoconductor F01 in FIG. 2) to a predetermined potential. Examples of the charging section include a non-contact charging form such as a corona charging form by an electric charger, and a contact charging by a charging roller or a charging brush.

The exposing section 31 includes a semiconductor laser as a light resource, and irradiates laser beam light output from the light source, onto the surface of photoconductor 1 between the charger 32 and the developer 33, thereby applying exposure corresponding to image information, onto the outer peripheral face of the photoconductor 1 charged. The light is scanned repeatedly in a direction of extension of the rotation axis line 44 of the photoconductor 1, which is a main scanning direction, and these create an image and serially forms an electrostatic latent image on the surface of the photoconductor 1. In other words, presence and absence of laser beam irradiation generate difference in the amount of charge on the photoconductor 1 charged uniformly by the charger 32, and form an electrostatic latent image.

The developer 33 is a developing section that develops the electrostatic latent image, which is formed on the surface of the photoconductor 1 by exposure, with a developing agent (toner); is disposed with facing the photoconductor 1; and includes a development roller 33a that supplies toner to the outer peripheral face of the photoconductor 1, and a casing 33b that rotatably supports the development roller 33a around a rotation axis line parallel to the rotation axis line 44 of the photoconductor 1, as well as contains the developing agent including toner within the inner space.

The transfer charger 34 is a transferring section that transfers the toner image, which is a visible image formed on the outer peripheral face of the photoconductor 1 by the development, on a transfer paper sheet 51, which is a recording medium supplied between the photoconductor 1 and the transfer charger 34 from a direction of an arrow symbol 42 by a conveying section not depicted. The transfer charger 34 is a contact transferring section that includes, e.g., a charging section, and provides polar charge opposite to toner on the transfer paper sheet 51, thereby transferring the toner image onto the transfer paper sheet 51.

The cleaner 36 is a cleaning section that removes and recovers toner remaining on the outer peripheral face of the photoconductor 1 after the transferring operation by the transfer charger 34, and includes a cleaning blade 36a that peels off the toner remaining on the outer peripheral face of the photoconductor 1, and a collecting casing 36b that contains the toner peeled off by the cleaning blade 36a. The cleaner 36 is also disposed with a static eliminating lamp not depicted.

The image-forming apparatus 100 also includes a fixture 35, which is a fixing section that fixes the image thus transferred, in a downstream part to which the transfer paper sheet 51 passed between the photoconductor 1 and the transfer charger 34 is to lie conveyed. The fixture 35 includes a heating roller 35a that has a heating section not depicted, and a compression roller 35b that is disposed with facing the heating roller 35a and compressed by the heating roller 35a to form a contact part.

The symbol 37 indicates a separating section that separates the transfer paper sheet and the photoconductor, and the symbol 38 indicates a housing that contains each of the section described above in the image-forming apparatus.

An image forming operation by the image-forming apparatus 100 is performed as follows.

First, once the photoconductor 1 is rotationally driven in the direction of the arrow symbol 41 by the driving section, the surface of the photoconductor 1 is uniformly charged to a predetermined positive potential by the charger 32 disposed in the proximity of the upstream part of the rotational direction of the photoconductor 1 relative to an image formation point of the light by the exposing section 31.

Then, light corresponding to image information is irradiated from the exposing section 31 to the surface of the photoconductor 1. In the photoconductor 1, the exposure removes surface charge of an area irradiated with the light, generates a difference between a surface potential of the area irradiated with the light and a surface potential of an area unirradiated with light, and forms an electrostatic latent image.

From the developer 33 disposed in the proximity of the downstream part of the rotational direction of the photoconductor 1 relative to the image formation point of the light by the exposing section 31, toner is supplied onto the surface of the photoconductor 1 forming an electrostatic latent image, and then the electrostatic latent image is developed to form a toner image.

With synchronization with the exposure to the photoconductor 1, the transfer paper sheet 51 is supplied between the photoconductor 1 and the transfer charger 34. The transfer charger 34 provides the transfer paper sheet 51 thus supplied with polar charge opposite to the toner, and transfers the toner image formed on the surface of the photoconductor 1 onto the transfer paper sheet 51.

The transfer paper sheet 51 having the toner image thus transferred is conveyed to the fixture 35 by a conveying section, heated and compressed in passing through the contact part of the heating roller 35a and the compression roller 35b of the fixture 35, and the toner image is fixed on the transfer paper sheet 51 to be a robust image. The transfer paper sheet 51 having an image formed in this manner is discharged out of the image-forming apparatus 100 by the conveying section.

Meanwhile, toner still remaining on the surface of the photoconductor 1 after the transfer of the toner age by the transfer charger 34 is peeled off and recovered from the surface of the photoconductor 1 by the cleaner 36. The charge on the surface of the photoconductor 1 that experiences removal of the toner in this manner is removed by light emitted from the charge eliminating lamp, and the electrostatic latent image on the surface of the photoconductor 1 disappears. Then, the photoconductor 1 is further rotationally driven, and the series of operations from charging is repeated again to form images consecutively.

The image-forming apparatus 100 describe above is a monochrome image-forming apparatus (printer), but may be, for example, a color image-forming apparatus with an intermediate transfer system capable of forming a color image. In particular, this may be a configuration where a plurality of electrophotographic photoconductors to individually form a toner image is arranged in a predetermined direction (e.g., a horizontal direction H or an approximately horizontal direction so-called a tandem full-color image-forming apparatus. The image-forming apparatus 100 may also be another color image-forming apparatus, a copier, a multifunction printer, or a facsimile apparatus.

(4-2) Electrophotographic Photoconductor

A photoconductor mounted in the image-forming apparatus according to an embodiment of the present disclosure includes an outermost layer containing a silica filler.

Inclusion (distribution) of a silica filler on the outermost layer can provide a photoconductor with higher tolerance against mechanical stress, and achieve extended long-life.

An exemplary photoconductor of the image-for apparatus according to an embodiment of the present disclosure will now be described below with use of the drawings, but the present disclosure is not limited thereto.

FIG. 2 is a schematic cross-sectional view illustrating a configuration of a main part of a photoconductor (stacked photoconductor) F01.

The stacked photoconductor F01 includes a substratum layer F21, and a photoconductive layer where a charge generation layer F22 containing a charge generation substance and a charge transport layer F23 containing a charge transport substance are stacked in this order on a substrate F1; and contains a silica filler in the charge transport layer F23, which is to be the outermost layer. In the figure, Fa indicates a surface of the photoconductor.

(4-3) Silica Filler

Examples of the silica filler include silica particles commonly used in the art, e.g., dry silica particles such as fumed silica derived by burning silicon tetrachloride, and arc silica derived by forming silica into microparticles in a vapor phase with high energy such as plasma; wet silica particles such as precipitated silica derived by synthesis from an aqueous sodium silicate solution as a raw material in an alkaline condition, and gelled silica derived by synthesis in an acid condition; colloidal silica particles derived by alkalifying and polymerizing acidic silicate; and sol-gel silica particles derived by hydrolysis of an organic silane compound. To improve an electrical property of a photoconductor, surface finishing may be made with a surface finishing agent.

The content of the silica filler in the outermost layer is about 7-25% by mass.

The mean primary particle diameter of the silica filler is not particularly limited, but is preferably 30 nm.

When the mean primary particle diameter of the silica filler is more than 30 urn, a larger structure of aggregates may generate in the outermost layer, thus tending to cause a problem such as cleaning failure. Alternatively, when the mean primary particle diameter of the silica filler is too small, printing durability may not be provided sufficiently, and the lower limit is about 7 nm.

The mean primary particle diameter of the silica filler is preferably 10-20 nm.

### EXAMPLES

The present disclosure will now be particularly described below with reference to the examples and the comparative examples, but the present disclosure is not limited to the following examples unless it is departing from the spirit.

In the examples and the comparative examples, each physical property value was measured by the method shown below.

In the following, “part” and “%” mean “mass part” and “% by mass”, respectively, unless otherwise stated.

Adhesion Strength of External Additive

Adhesion strength of external additives are measured by the following procedure.

(1) Add 2.0 g of toner to 40 mL of an aqueous Triton (polyoxyethylene octylphenyl ether) solution with a concentration of 0.2% by mass and stir for 1 minute.

(2) Further irradiate the aqueous solution described above with ultrasonic waves at an output of 40 μA for 2 minutes using a homogenizer (manufactured by Nihon Seiki Kaisha Ltd., model: US-300T).

(3) Leave the sonicated aqueous solution standing for 3 hours to separate the toner from an external additive thus released.

(4) After removal of a supernatant, add about 50 mL of pure water to the precipitate, and stir for 5 minutes.

(5) Perform suction filtration using a membrane filter with a pore size of 1 μm (manufactured by Advantech Co., Ltd.)

(6) Dry in vacuo the toner remaining on the filter overnight.

(7) Analyze intensities of elements (Si, Ti) in an external additive in 1 g of a toner before and after a series of the sonication procedure (1)-(6) described above using a fluorescent X-ray analyzer (manufactured by Rigaku Corporation, model: ZSX Primus II), and calculate adhesion strength a of the external additive in accordance with the following formulae.

Adhesion strength of external additive a (%)=[(fluorescent X-ray intensity of Si element after sonication)/(fluorescent X-ray intensity of Si element before sonication)]×100

Adhesion strength of external additive b (%)=[(fluorescent X-ray intensity of Ti element after sonication)/(fluorescent X-ray intensity of Ti element before sonication))]×100

Adhesion strength a=b/a

Mean Primary Particle Diameter of Each External Additive (nm) With regard to a mean primary particle diameter of each external additive, a scanning electron microscope (SEM) (manufactured by Hitachi High-Tech Corporation, model: S-4800) is used to take an image of particles, and 50% particle diameter is calculated based on the number of particles measured by equivalent circle diameter from the image thus obtained, and is defined as the mean primary particle diameter.

Mean Primary Particle Diameter of Toner Base Particle (μm)

To 50 mL of an electrolyte solution (manufactured by Beckman Coulter, Inc., trade name: ISOTON-III), 20 mg of a sample and 1 mL of sodium alkyl ether sulfate is added, and subjected to dispersion at a frequency of 20 kHz for 3 minutes using an ultrasonic disperser (manufactured by AS ONE Corporation, bench-top dual-frequency ultrasonic washer, model: VS-D100) to obtain a measurement sample. The measurement sample thus obtained is measured. with a particle size distribution measuring device (manufactured by Beckman Coulter, Inc., model: Multisizer 3) under a condition at an aperture size of 100 μm with the number of measured particle of 50000 counts, and a mean primary particle diameter (μm) is derived from a volume particle size distribution of the sample particles.

Coverage of External Additive

Assuming that respective particles of an external additive has the same particle diameter of their mean primary particle diameter as the whole surface of a toner base particle covered with the external additive in a closest packing manner is defined as 100%, coverage of the external additive is calculated from the mean primary particle diameter of the external additive and the surface area of the toner base particle.

In particular, a value derived by the total projected area of an external additive calculated as described below by the total surface area of a toner is defined as coverage of the external additive.

At first, a projected area per particle is calculated from the particle diameter of an external additive by the formula for the area of a circle. Next, the volume of the external additive is derived by the formula for the volume of a sphere, and multiplied with specific gravity to derive the weight of the external additive, and further subjected to calculation of the number of the external additive particles per toner particle, which is derived from the weight of the toner using the parts by addition weight and the weight of a single particle of the external additive. The sum of the projected area per particle is calculated from the number of the external additive particles. The total surface area of the toner is derived from the surface area of a single particle of the toner by the formula for the surface area of a sphere.

### Example 1

Preparation of Toner Base Particles

The toner base particles used in the examples and the comparative examples were prepared as follows.

Binder resin: 100 mass parts of polyester resin (glass-transition point: 55° C. softening temperature: 105° C.)

Colorant: 10 mass parts of carbon black (manufactured by Mitsubishi Chemical Corporation, product name: MA-100)

Mold lubricant: 5 mass parts of wax (microcrystalline wax, melting point: 80° C., manufactured by Nippon Seiro Co., Ltd., product name: Hi-Mic-1070)

The materials as described above were mixed and dispersed for 3 minutes using an air flow mixer (Henschel mixer, manufactured by Mitsui Mining Co., Ltd. (current Nippon Coke and Engineering Co., Ltd.), model: FM20C), and then melt-kneaded using a dual-screw excluder (manufactured by Ikegai Corporation, model: PCM-30) under a condition at a cylinder setting temperature of 110° C. at a barrel rotation rate of 300 rpm at a raw material supply speed of 20 kg/hour to provide a melt-kneaded material. The melt-kneaded material thus obtained was cooled on a cooling belt, and then roughly milled with a speed mill having a φ1 mm screen to provide a roughly-milled product with a particle size of 1 mm.

The roughly-milled material thus obtained is finely milled with a counter jet mill (manufactured by Hosokawa Micron Corporation, model: AFG) to provide a group of finely-milled particles (finely-milled material) with a volume mean particle diameter of 6.2 μm.

The finely-milled material thus obtained is classified with a rotary classifier (manufactured by Hosokawa Micron Corporation, model: TSP separator) to provide toner base particles with no external addition and a volume mean particle diameter of 6.7 μm.

Preparation of Externally-Added Fine Powder

After metatitanic acid derived by a sulfuric acid method was deionized and bleached, an aqueous sodium hydroxide solution was added up to pH 9.0 to perform desulfurization, then neutralized to pH 5.8 with hydrochronic acid, and subjected to filtration and washing to provide a washed cake. Water was added to the washed cake to produce a slurry, and hydrochronic acid is added up to pH 1.4 to perform peptization. The metatitanic acid thus obtained was charged into a reaction container, and a strontium chloride solution and sodium silicate are added. Then, after heating at a temperature of 90° C. with stirring, a 10N aqueous sodium hydroxide solution was added for 2 hours, and subsequently stirring continued at a temperature of 95° C. for 1 hour until the reaction ended.

After the end of the reaction, the slurry thus obtained was cooled to a temperature of 50° C., subjected to addition of hydrochronic acid up to pH 5.0, and continued to be stirred for 1 hour. The precipitate thus obtained was decanted and washed, and then subjected to solid-liquid separation by filtration.

Subsequently, the solid material thus obtained was hydrophobized with a silane compound, and then subjected to solid-liquid separation by filtration, and the solid material was dried at a temperature of 120° C. in the air for 1.0 hours to provide externally-added fine powder containing strontium titanate as a main component (the molar ratio Si/Ti of silicon Si in silica to titanium Ti in strontium titanate=0.058). The number mean primary particle diameter was 40 nm.

External Addition

The toner base particles thus obtained and silica particles (mean primary particle diameter: 7 nm, manufactured by Nippon Aerosil Co., Ltd., trade name: R976) as externally-added silica in an amount corresponding to a coverage of 100% for the toner base particle was charged into an FM mixer (manufactured by Nippon Coke & Engineering Co., Ltd., model: FM-20), and mixed for 1 minute with setting a circumferential speed to 40 m/sec in the outermost circumference of the tip of a stirring blade (first external addition process).

Then, externally-added fine powder in an amount corresponding to a coverage of 5% for the toner base particle was charged into the FM mixer, and mixed for 1.5 minutes with setting a circumferential speed to 40 m/sec in the outermost circumference of the tip of a stirring blade (second external addition process).

The mixture thus obtained was sieved 70-mesh sieve to provide an externally-added toner.

Preparation of Developing Agent

The externally-added toner thus obtained and a coating carrier (manufactured by Sharp Corporation, name: genuine carrier for MX-5111FN) were charged into a V-type mixer (manufactured by Tokuju Corporation, trade name: V-5) so as to provide a toner concentration of 7% by mass, and mixed for 20 minutes to provide a two-component developing agent.

### Example 2

A toner and a two-component developing agent was obtained and evaluated in the same manner as in Example 1, except for using silica particles (mean primary particle diameter: 16 nm, manufactured by Nippon Aerosil Co., Ltd., trade name: 8972) as externally-added silica in the aforementioned “External Addition”.

### Example 3

A toner and a two-component developing agent was obtained and evaluated in the same manner as in Example 1, except for using silica particles (mean primary particle diameter: 40 nm, manufactured by Nippon Aerosil Co., Ltd., trade name: RY50) as externally-added silica in the aforementioned. “External Addition”.

### Example 4

A toner and a two-component developing agent was obtained and evaluated in the same manner as in Example 1, except for setting the external addition amount of externally-added silica to an amount corresponding to a coverage of 20% for toner base particle in the aforementioned “External Addition”.

### Example 5

A toner and a two-component developing agent was obtained and evaluated in the same manner as in Example 1, except for setting the external addition amount of externally-added silica to an amount corresponding to a coverage of 150% for toner base particle in the aforementioned “External Addition”.

### Example 6

A toner and a two-component developing agent was obtained and evaluated in the same manner as in Example 1, except for setting the external addition amount of externally-added fine powder to an amount corresponding to a coverage of 1% for toner base particle in the aforementioned “External Addition”.

### Example 7

A toner and a two-component developing agent was obtained and evaluated in the same manner as in Example 1, except for setting the external addition amount of externally-added fine powder to an amount corresponding to a coverage of 20% for toner base particle in the aforementioned “External Addition”.

### Example 8

A toner and a two-component developing agent was obtained and evaluated in the same manner as in Example 1, except for charging toner base particles provided, and silica particles as externally-added silica in an amount corresponding to a coverage of 100% for the toner base particle into the FM mixer, mixing for 1.5 minute with setting a circumferential speed to 40 m/sec in the outermost circumference of the tip of a stirring blade (first external addition process), then charging externally-added fine powder in an amount corresponding to a coverage of 5% for the toner base particle into the FM mixer, and mixing for 0.5 minutes with setting a circumferential speed to 30 m/sec in the outermost circumference of the tip of a stirring blade (second external addition process) to provide a ratio b/a of adhesion strength of the externally-added fine powder b to adhesion strength of the externally-added silica a of 0.1, in the aforementioned “External Addition”.

### Example 9

A toner and a two-component developing agent was obtained and evaluated in the same manner as in Example 1, except for charging toner base particles provided, and silica particles as externally-added silica in an amount corresponding to a coverage of 100% for the toner base particle into the FM mixer, mixing for 0.5 minute with setting a circumferential speed to 30 m/sec in the outermost circumference of the tip of a stirring blade (first external addition process), then charging externally-added fine powder in an amount corresponding to a coverage of 5% for the toner base particle into the FM mixer, and mixing for 1.5 minutes with setting a circumferential speed to 40 m/sec in the outermost circumference of the tip of a stirring blade (second external addition process) to provide a ratio b/a of adhesion strength of the externally-added fine powder b to adhesion strength of the externally-added silica a of 0.6, in the aforementioned “External Addition”.

### Comparative Example 1

A toner and a two-component developing agent was obtained and evaluated in the same manner as in Example 1, except for using 2 mass parts of a charge regulator (manufactured by Hodogaya Chemical Co., Ltd., trade name: TRH) in the aforementioned “Preparation of Toner Base Particles”.

### Comparative Example 2

A toner and a two-component developing agent obtained in the same manner as in Example 1 was used and evaluated using an image-forming apparatus mounted with an electrophotographic photoconductor including an outermost layer not containing a silica filler.

### Comparative Example 3

A toner and a two-component developing agent was obtained and evaluated in the same manner as in Example 1, except for not externally adding externally-added fine powder in the aforementioned “External Addition”.

Evaluation

Evaluation 1: Low-Temperature Fixability

A commercially-available copier (manufactured by Sharp Corporation, model: MX-5100FN) modified for evaluation was used to form a fixed image with a two-component developing agent.

At first, a sample image including a solid black image (a rectangle 20 mm long and 50 mm wide) was formed as an unfixed image on a recording paper sheet (manufactured by Sharp Corporation, PPC paper, model: SF-4AM3). At that time, an adhesion amount of toner to the recording paper sheet in the solid black image was adjusted to provide 0.5 mg/cm^{2.}

Next, a fixed image was created with a hard roller fixation devise.

With setting a fixation process speed to 120 mm/sec, temperature of a fixation roller was raised from 140° C. by an increment of 5° C. to derive the minimum temperature where low-temperature offset was generated.

The term “low-temperature offset” defines that toner remains adhered to a fixation belt rather than fixes onto a recording paper sheet at fixation, and then adheres to a recording paper sheet after a circuit of the fixation belt.

“Low-temperature fixability” was judged from the results thus obtained according to the following criteria:

++: Good (generating offset at a temperature of 160° C.)

+: Passed (generating offset at a temperature of 165° C.)

−: Failed (generating offset at a temperature of 170° C.)

Evaluation 2: Charge Environmental Stability (Environmental Variance)

A toner and a ferrite core carrier with a mean primary particle diameter of 60 μm were mixed so as to provide a toner concentration of 5% by mass, to produce a two-component developing agent.

Using suction charge measuring device (manufactured by Trek Japan K. K., model: 210HS), measurement was performed for a charge amount in normal temperature and humidity Q1 (20° C., 50% RH) and a charge amount in high temperature and humidity Q2 (35° C., 85%) in the two-component developing agent thus obtained. The ratio Q2/Q1 of charge amount Q1 to charge amount Q2×100 (%) was derived as an index of charge environmental stability.

“Charge environmental stability” was judged from the results thus obtained according to the following criteria:

++: Good (having a ratio Q2/Q1×100 of 60% or more)

+: Passed (having a ratio Q2/Q1×100 of 50% or more to less than 60%)

−: Failed (having a ratio Q2/Q1×100 of less than 50%)

Evaluation 3: Abrasion to Photoconductor (Scratch)

The surface of a photoconductor after the evaluation for low-temperature fixability was visually observed and judged according to the following criteria:

++: Good (having no noticeable scratch)

+: Passed (having a scratch, but providing a slight effect and being acceptable for practical use)

−: Failed (having a problem in a scratch, and providing a great affect and being unacceptable for practical use)

Evaluation 4: Filming

The whole of a solid black printing in the evaluation for low-temperature fixability was visually observed and judged according to the following criteria:

++: Good (no problem in a printing)

+: Passed (having filming in a printed part, but providing a slight effect and being acceptable for practical use)

−: Failed (having a problem in a printed part, and providing a great affect and being unacceptable for practical use)

Overall Evaluation

The results of Evaluations 1-4 were subjected to overall evaluation (judgment) according to the following criteria:

++: Good (having only “++”)

+: Practical level (having no “−” and at least one “+”)

−: Bad (having at least one “−”)

Table 1 summarizes evaluation results with conditions for photoconductors, toners, and external additives.

TABLE 1

| | Toner Composition | | | | | | |
|---|---|---|---|---|---|---|---|
| | | | | | | Adhesion | Photoconductor |
| | Toner | Externally-added | | Externally-added | | Strength | Silica |
| | Base | Silica | | Fine Powder | | of | Filler |
| | Particle | Particle | | Particle | | External | Particle |
| | Charge | Diameter | Coverage | Diameter | Coverage | Additive | Diameter |
| | Regulator | (nm) | (%) | (nm) | (%) | α | (nm) |
| Example 1 | No | 7 | 100 | 40 | 5 | 0.25 | 16 |
| Example 2 | No | 16 | 100 | 40 | 5 | 0.25 | 16 |
| Example 3 | No | 40 | 100 | 40 | 5 | 0.25 | 16 |
| Example 4 | No | 7 | 20 | 40 | 5 | 0.25 | 16 |
| Example 5 | No | 7 | 150 | 40 | 5 | 0.25 | 16 |
| Example 6 | No | 7 | 100 | 40 | 1 | 0.25 | 16 |
| Example 7 | No | 7 | 100 | 40 | 20 | 0.25 | 16 |
| Example 8 | No | 7 | 100 | 40 | 5 | 0.1 | 16 |
| Example 9 | No | 7 | 100 | 40 | 5 | 0.6 | 16 |
| Comparative | Yes | 7 | 100 | 40 | 5 | 0.25 | 16 |
| Example 1 | | | | | | | |
| Comparative | No | 7 | 100 | 40 | 5 | 0.25 | Not |
| Example 2 | | | | | | | added |
| Comparative | No | 7 | 100 | Not | — | — | 16 |
| Example 3 | | | | added | | | |

| | Rating | | | | |
|---|---|---|---|---|---|
| | Low- | Charge | | | |
| | temperature | Environmental | Abrasion to | | Overall |
| | Fixability | Stability | Photoconductor | Filming | Eating |
| Example 1 | ++ | ++ | ++ | ++ | ++ |
| Example 2 | ++ | ++ | ++ | ++ | ++ |
| Example 3 | + | + | ++ | ++ | + |
| Example 4 | ++ | + | ++ | ++ | + |
| Example 5 | + | ++ | ++ | ++ | + |
| Example 6 | ++ | + | ++ | ++ | + |
| Example 7 | + | ++ | + | + | + |
| Example 8 | ++ | + | ++ | ++ | + |
| Example 9 | ++ | ++ | ++ | + | + |
| Comparative | − | ++ | ++ | ++ | − |
| Example 1 | | | | | |
| Comparative | ++ | ++ | − | − | − |
| Example 2 | | | | | |
| Comparative | ++ | − | ++ | − | − |
| Example 3 | | | | | |

The results in Table 1 reveals the following:

(1) A toner and a developing agent in the present disclosure (Examples 1-9) can achieve low-temperature fixation and extended long-life

(2) A larger mean primary particle diameter of externally-added silica leads to reduction in low-temperature fixability and charge environmental stability (Example 3)

(3) A smaller external addition amount (lower coverage) of externally-added silica leads to reduction in charge environmental stability (Example 4), whereas a larger external addition amount (higher coverage) of externally-added silica leads to reduction in low-temperature fixability (Example 5)

(4) A smaller external addition amount (lower coverage) of externally-added fine powder leads to reduction in charge environmental stability (Example 6), whereas a larger external addition amount (higher coverage) of externally-added silica leads to reduction in low-temperature fixability (Example 7)

(5) A smaller ratio b/a of adhesion strength of externally-added fine powder b to adhesion strength of externally-added silica a leads to reduction in charge environmental stability (Example 8), whereas a larger ratio b/a leads to more likelihood of filming (Example 9)

(6) Inclusion of a charge regulator in toner base particles leads to poor low-temperature fixability, thus failing to ensure desired low-temperature fixability (Comparative Example 1)

(7) Absence of use with an image-forming apparatus mounted with an electrophotographic photoconductor having an outermost layer containing a silica filler leads to generation of a scratch on a photoconductor (abrasion on the photoconductor) and occurrence of filming, thus being unacceptable for practical use (Comparative Example 2)

(8) Absence of external addition of externally-added fine powder leads to reduction in charge environmental stability and occurrence of filming, thus being unacceptable for practical use (Comparative Example 3)

The present disclosure is expected to provide effects as the following:

Having an effect to provide chargeability and flowability by externally-added silica

Adjusting a charge amount to be appropriate without impairing an effect of silica to provide a toner with flowability, by externally adding strontium titanate fine powder with small-sized silica to a toner; strontium titanate fine powder has electrical conductivity and a function to transmit, to surrounding particles, negative charge of a toner particle charged locally or to release the negative charge in the air by external addition onto the surface of toner

Improving cleaning property on the surface of a photoconductor drum by externally adding strontium titanate fine powder onto the surface of a toner with low adhesion strength and thereby causing an external additive coming off from the surface of the toner to be present between the drum and a cleaning roller

With a toner not containing a charge regulator, achieving further low-temperature fixation due to extension of a fixation area to a lower temperature part

Achieving extended long-life by preventing abrasion of a drum with use of an electrophotographic photoconductor including an outermost layer containing silica filler (silica filler drum)

What is claimed is:

1. An electrophotographic apparatus that forms an image by forming an electrostatic latent image on a surface of an electrophotographic photoconductor and transferring a toner developed in the electrostatic latent image to a transfer material,
wherein the electrophotographic photoconductor comprises an outermost layer containing a silica filler,
wherein the toner comprises a toner base particle and an external additive as components, the toner base particles at least comprising a binder resin, a colorant, and a mold lubricant, and
wherein the external additive represents externally-added silica and externally-added fine powder, the externally-added fine powder having a surface of a core hydrophobized with a silane compound, the core being derived by addition of silica to strontium titanate.

2. The electrophotographic apparatus according to claim 1, wherein an external addition amount of the externally-added fine powder is an amount corresponding to a coverage of 2-10% for the toner base particle.

3. The electrophotographic apparatus according to claim 1, wherein a ratio b/a of adhesion strength of the externally-added fine powder b to adhesion strength of the externally-added silica a for the toner base particle meets a relation of 0.15≤a≤0.5.

4. The electrophotographic apparatus according to claim 1, wherein a molar ratio Si/Ti of silicon Si in silica to titanium Ti in strontium titanate in the externally-added fine powder is 0.03 or more to less than 1.0.

5. The electrophotographic apparatus according to claim 1, wherein a mean primary particle diameter of the externally-added silica is 6-17 nm.

6. The electrophotographic apparatus according to claim 1, wherein an external addition amount of the externally-added silica is an amount corresponding to a coverage of 50-120% for the toner base particle.

7. The electrophotographic apparatus according to claim 1, wherein the toner base particle comprises no charge regulator.

8. The electrophotographic apparatus according to claim 1, wherein the toner is a two-component developing agent comprising a carrier.
